(19) United States
(12) Patent Application Publication
(10) Pub. No.: US 2025/0141791 A1
(43) Pub. Date: May 1, 2025

(54) HYBRID OVERLAY AND UNDERLAY PATH SELECTION

(71) Applicant: Cisco Technology, Inc., San Jose, CA (US)

(72) Inventors: Lianxiang Wang, Shanghai (CN); Jiaoming Li, Shanghai (CN); Pan Wu, Shanghai (CN); Yunpeng Zhang, Shanghai (CN)

(21) Appl. No.: 18/384,552

(22) Filed: Oct. 27, 2023

(51) Int. Cl. H04L 45/00; H04L 45/50; H04L 45/64

(52) U.S. Cl. CPC H04L 45/38; H04L 45/50; H04L 45/64

(57) ABSTRACT

Techniques for achieving hybrid control over overlay and underlay path selection by integrating underlay path identities into software-defined wide area network (SD-WAN) sessions to create individual SD-WAN sessions for each underlay path. The techniques may include receiving first path identification data associated with an underlay path of an overlay network domain that is disposed between a first edge node and a second edge node of an SD-WAN system. Based on the first path identification data, an SD-WAN session may be generated that is to utilize the underlay path for sending traffic through the overlay network domain. In some examples, the underlay path may be mapped to the SD-WAN session and the SD-WAN session may be bound to a data plane output forwarding chain associated with the underlay path such that the traffic sent over the SD-WAN session traverses the underlay path of the overlay network domain.

### TECHNICAL FIELD

The present disclosure relates generally to techniques for, among other things, achieving hybrid control over overlay and underlay path selection by exposing underlay paths to a software-defined wide area network (SD-WAN) architecture and generating individual SD-WAN sessions for individual underlay paths. In this way, SD-WAN path selection that incorporates both the underlay path and overlay path can naturally be applied on those SD-WAN sessions.

### BACKGROUND

In today's software-defined wide area networking (SD-WAN) solutions, path selection is based on a topology of an overlay network. For instance, an SD-WAN architecture may be able to select from an internet domain overlay or a Multiprotocol Label Switching (MPLS) domain overlay to send traffic from one SD-WAN edge node to another SD-WAN edge node, but across each overlay domain only one path is used. In many cases, however, overlay and other core network domains have their own traffic engineering technology and provide multiple paths to choose from. For example, in an MPLS domain, there may be a Segment-Routing policy configured for different paths and metrics.

Today, in order to control the selection of underlay paths within an overlay domain, two steps are required. The first step is to select an overlay path, such as the internet, MPLS, or the like. Then, in the second step, a policy must be configured within the core network itself (e.g., in MPLS core network) to steer the traffic to an underlay path. In other words, this means that the SD-WAN is not capable of controlling the selection of overlay and underlay paths together. Furthermore, by requiring a two-step process, the SD-WAN does not have full knowledge of the underlay paths during the path selection process.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. The systems depicted in the accompanying figures are not to scale and components within the figures may be depicted not to scale with each other.

FIG. 1 illustrates an example architecture that may implement various aspects of the technologies described herein for hybrid control, by an SD-WAN system, over overlay and underlay path selection.

FIG. 2 is a flow diagram illustrating an example method associated with the techniques described herein.

FIG. 3 is a flow diagram illustrating another example method associated with the techniques described herein.

FIG. 4 is a block diagram illustrating an example packet switching system that can be utilized to implement various aspects of the technologies disclosed herein.

FIG. 5 is a block diagram illustrating certain components of an example node that can be utilized to implement various aspects of the technologies disclosed herein.

FIG. 6 is a computer architecture diagram showing an illustrative computer hardware architecture for implementing a computing device that can be utilized to implement aspects of the various technologies presented herein.

### DESCRIPTION OF EXAMPLE EMBODIMENTS

### Overview

This disclosure describes various technologies for achieving hybrid control over overlay and underlay path selection by exposing underlay paths to a software-defined wide area network (SD-WAN) architecture and generating individual SD-WAN sessions for individual underlay paths. In this way, SD-WAN path selection that incorporates both the underlay path and overlay path can naturally be applied on those SD-WAN sessions. By way of example, and not limitation, the techniques described herein may include receiving first path identification data associated with an underlay path of an overlay network domain, the overlay network domain disposed between a first edge node and a second edge node of an SD-WAN system. The techniques may also include generating an SD-WAN session that is to utilize the underlay path for sending traffic through the overlay network domain from the first edge node to the second edge node. In some examples, the underlay path may be mapped to the SD-WAN session and the SD-WAN session may be bound to a data plane output forwarding chain associated with the underlay path such that the traffic sent over the SD WAN session traverses the underlay path of the overlay network domain.

Additionally, the techniques described herein may be performed as a method and/or by a system having non-transitory computer-readable media storing computer-executable instructions that, when executed by one or more processors, performs the techniques described above and herein.

### Example Embodiments

As noted above, in order to control the selection of underlay paths within an overlay domain in today's SD-WAN architectures, two steps are required. The first step is to select an overlay path, such as the internet, MPLS, or the like. Then, in the second step, a policy must be configured within the core network itself (e.g., in MPLS core network) to steer the traffic to an underlay path. In other words, this means that the SD-WAN is not capable of controlling the selection of overlay and underlay paths together. Furthermore, by requiring a two-step process, the SD-WAN does not have full knowledge of the underlay paths during the path selection process.

This application is directed to technologies for achieving hybrid control over overlay and underlay path selection by exposing underlay paths to a software-defined wide area network (SD-WAN) architecture and generating individual SD-WAN sessions for individual underlay paths. In this way, SD-WAN path selection that incorporates both the underlay path and overlay path can naturally be applied on those SD-WAN sessions. For example, an SD-WAN session's key may currently be defined as: (source IP, destination IP, source Color, remote Color, encapsulation). Additionally, a Segment-Routing underlay path's key may currently be defined as: (headend IP, tail end IP, color). In some examples, the color of a Segment-Routing policy definition may actually be the underlay Path ID between the headend and tail end. The techniques disclosed herein introduce and leverage a new value in the SD-WAN session/session key, referred to herein as “sub-encapsulation.” As such, under this new definition, the SD-WAN session's key is redefined as: (source IP, destination IP, source Color, remote Color, encapsulation, sub-encapsulation). In some examples, the techniques disclosed herein may map underlay paths to newly created SD-WAN sessions such that the underlay path's headend IP is mapped to the SD-WAN session's source IP, the underlay path's tail end IP is mapped to the SD-WAN session's destination IP, and the underlay path ID (e.g., SR color) is mapped to the SD-WAN session's sub-encapsulation value. In this way, the SD-WAN session's encapsulation and color may be derived from the interface's configuration.

Additionally, in some examples, the SD-WAN session may be bound to the underlay path's data plane output forwarding chain. According to Segment-Routing path mechanisms, the traffic steering to a specific path may not be forwarded according to normal routing, so instead traffic may be forwarded using a label stack identified by a Binding SID (segment identifier). The disclosed techniques may associate each underlay path's binding SID to a corresponding SD-WAN session. In this way, traffic being sent via a particular SD-WAN session will get the underlay path's forwarding chain (e.g., egress label stack) from the Binding SID.

In some examples, Bidirectional Forwarding Detection (BFD) sessions of each SD-WAN session may be sent without any change. Because the SD-WAN session has Binding SID to get egress label stack, the BFD packet may follow the underlay path in MPLS core network and get the probe metric of that underlay path, it is aligned with current SD-WAN architecture.

In examples, since the SD-WAN session for each underlay path has been generated and BFD packet can be used to probe the metrics, SD-WAN AAR policy and/or data policy may be applied to those SD-WAN sessions without any change. In some examples, it may co-exist with legacy SD-WAN sessions (e.g., the sub-encapsulation value for legacy SD-WAN sessions may be “0”) without compatibility issues.

In examples, if there is no existing underlay path in core network, SD-WAN policies can be enhanced to define new profile (e.g. prefer Segment-Routing path with certain metrics). In such examples, this kind of policy profile may dynamically program Segment-Routing policy to create underlay paths, and then return a path ID as sub-encapsulation to generate new SD-WAN sessions for policy selection.

By way of example, and not limitation, a method according to the techniques disclosed herein may include receiving underlay path identification data associated with an underlay path of an overlay network domain, the overlay network domain disposed between a first edge node and a second edge node of a software defined wide area network (SD-WAN). In some examples, the underlay path identification data may include a Segment-Routing underlay path's key. For instance, the underlay path identification data may include a headend IP address associated with the underlay path, a tail end IP address associated with the underlay path, a color associated with the underlay path, a segment identifier or micro segment identifier associated with the underlay path, or other path identification data. In some examples, metrics associated with the underlay path may be received and/or determined. For instance, these metrics may include whether the path is a secure path (e.g., whether the path includes any network security components, firewalls, etc.), a number of hops in the path, whether the path is a shortest path or a low latency path, whether the path is a high bandwidth path, or the like.

In some examples, the method may include generating an SD-WAN session that is to utilize the underlay path for sending traffic through the overlay network domain from the first edge node to the second edge node. For instance, an SD-WAN system may create the session that is to be used for the traffic. In some examples, generating the SD-WAN session may include generating a new SD-WAN sessions key identifying the session. The SD-WAN session key may include values for a source IP address, destination IP address, source Color, remote Color, encapsulation, and sub-encapsulation.

In some examples, the SD-WAN session may be generated based at least in part on the underlay path identification data. In some examples, generating the SD-WAN session may include mapping the underlay path to the SD-WAN session such that the traffic sent over the SD WAN session traverses the underlay path of the overlay network domain. For instance, the underlay path may be mapped to the newly created SD-WAN session by mapping a headend IP address associated with the underlay path to a source IP address associated with the SD-WAN session, mapping a tail end IP address associated with the underlay path to a destination IP address associated with the SD-WAN session, and/or mapping a path identifier associated with the underlay path to a path key value associated with the SD-WAN session. In some examples, the path identifier may be a segment routing color associated with the underlay path. In some examples, the first path identification data that is received may include the headend IP address, the tail end IP address, and the path identifier.

In some examples, generating the SD-WAN session may additionally or alternatively include binding the SD-WAN session to a data plane output forwarding chain associated with the underlay path such that the traffic sent over the SD WAN session traverses the underlay path of the overlay network domain. In some examples, binding the SD-WAN session to the data plane output forwarding chain associated with the underlay path may entail associating, with the SD-WAN session, a binding segment identifier (SID) associated with the underlay path.

In some instances, the SD-WAN system may generate multiple different SD-WAN sessions for different, potential underlay paths that may be utilized. For instance, multiple underlay paths through a single overlay network may be associated with their own SD-WAN session. Similarly, underlay paths through different/distinguishable overlay networks may be associated with their own SD-WAN session. By establishing specific SD-WAN session for specific underlay paths, when the SD-WAN system decides which underlay path to use for a flow, the SD-WAN session is selecting the overlay at the same time. This improves prior techniques where SD-WAN systems may only have control over the overlay path (e.g., whether to push a flow through a first overlay network (e.g., internet) or through a second overlay network (e.g., MPLS)) and, if any control at all was capable in the underlay it was done in two steps, as described above.

In some examples, the SD-WAN system may associate different SD-WAN sessions with different policies based on the underlay path that a specific SD-WAN session is bound to. For instance, the SD-WAN system may use certain SD-WAN sessions where a firewall is included in the underlay for traffic that requires such, based on policy. Additionally, the SD-WAN system may use an SD-WAN session that is bound to a shortest path in the underlay for traffic that requires minimal latency and/or delay. In examples, different underlay paths may include different combinations of security and/or networking components and/or services.

In some examples, as packets of a flow move through the SD-WAN system, the packets may be classified (e.g., at an SD-WAN node, classifier, etc.) based on policy to determine whether the packet is to be sent through an overlay network via a specific underlay path. For instance, the packet may be classified based on a policy to determine if it needs to be sent via a secure underlay path, a minimum delay underlay path, a high bandwidth underlay path, or an underlay path providing any combination thereof. In some examples, the policy may be set by an organization or enterprise managing the SD-WAN system, the policy may be specified and/or carried in the traffic, the policy may be set by an application developer, or the like.

In some examples, once the underlay path for transporting the traffic is determined and/or selected, the packets/traffic may be modified to include information for steering the traffic along the underlay path. In some examples, this information may be a binding SID that is indicative of a label stack (e.g., MPLS label stack) for steering the packet along the underlay path. In some examples, the information may include next hop addresses for the underlay node(s) of the underlay path, or any other type of networking/routing information for indicating the path to the overlay network. In other words, the information that is included in the packet due to the modifying may convey the identity of the underlay path to the overlay network in which that underlay path is located.

According to the techniques disclosed herein, several advantages in computer-related technologies can be realized. For example, by exposing underlay paths to SD-WAN architecture and generating individual SD-WAN sessions for individual underlay paths, SD-WAN path selection that incorporates both the underlay path and overlay path (in a single-step process) can naturally be applied on those SD WAN sessions. Additionally, the techniques disclosed herein allow SD-WAN architectures with at least some visibility and control over the underlay paths through disparate overlay network domains. This allows the SD-WAN system the ability to guarantee that networking policies are met end-to-end for respective traffic flows moving through the SD-WAN. Furthermore, this allows the SD-WAN system to provide greater networking performance for its clients flows. These and other improvements in computer-related technology will be readily apparent to those having ordinary skill in the art.

Certain implementations and embodiments of the disclosure will now be described more fully below with reference to the accompanying figures, in which various aspects are shown. However, the various aspects may be implemented in many different forms and should not be construed as limited to the implementations set forth herein. The disclosure encompasses variations of the embodiments, as described herein. Like numbers refer to like elements throughout.

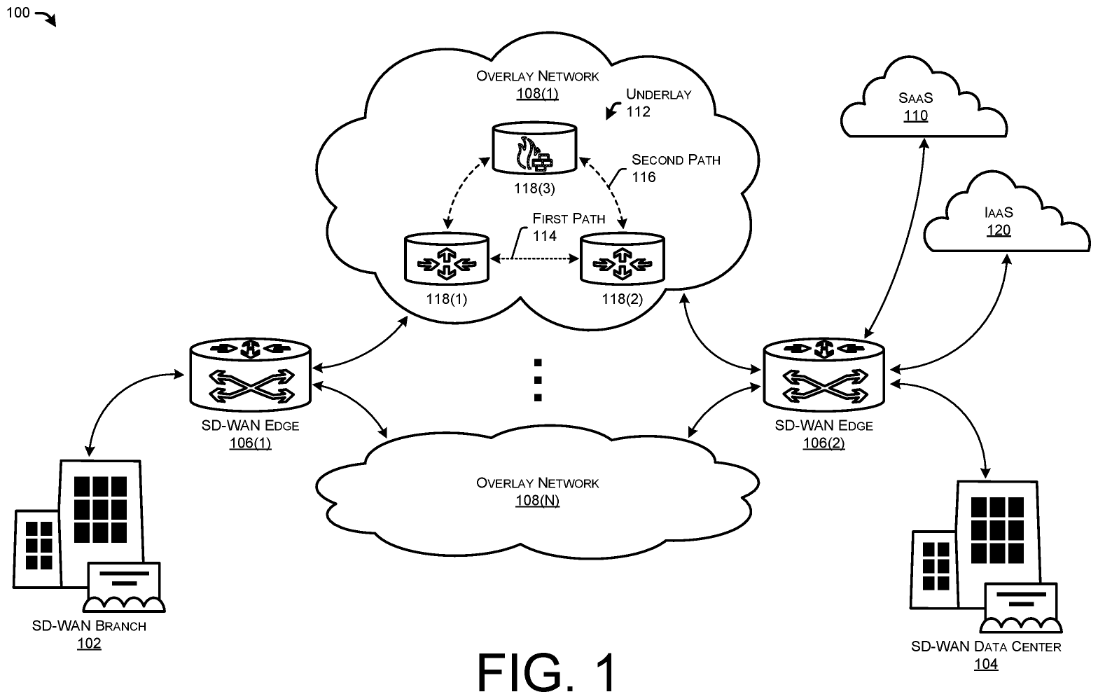

FIG. 1 illustrates an example architecture 100 that may implement various aspects of the technologies described herein for hybrid control, by an SD-WAN system, over overlay and underlay path selection. The architecture 100 includes an exemplary SD-WAN system, which itself includes an SD-WAN branch 102 (e.g., branch office), an SD-WAN data center 104, and SD-WAN edge nodes 106(1) and 106(2) (hereinafter referred to collectively as “SD-WAN edge nodes 106” or, simply, “edge nodes 106”). In examples, the SD-WAN system may facilitate or otherwise enable communications between the SD-WAN branch 102 and the SD-WAN data center 104, as well as communications with cloud-delivered Software as a Service offerings (e.g., SaaS 110) and Infrastructure as a Service offerings (e.g., IaaS 120).

Between the SD-WAN edge nodes 106, the architecture 100 includes one or multiple overlay networks, such as the overlay network 108(1) and the overlay network 108(N) (where N can be equal to any number representing a total number of overlay networks) (hereinafter referred to collectively as “overlay networks 108”). In examples, traffic flowing from the edge node 106(1) to the edge node 106(2), and vice-versa, may be sent over any one of the overlay networks 108.

Traditionally, the SD-WAN system would not have any control over the selection of a path through the underlay 112 of the overlay networks 108. That is, while the underlay 112 of the overlay network 108(1) offers both a first path 114 and a second path 116, as well as presumably more paths, the SD-WAN system, including the edge nodes 106, would not have any control over underlay path selection.

However, according to the techniques of this disclosure, the SD-WAN system may achieve hybrid control over both of the overlay path (e.g., whether to send traffic over the overlay network 108(1) as opposed to the overlay network 108(N)) and the underlay path at the same time. This allows the SD-WAN system to make policy decisions and select underlay paths that are best suited for traffic. For instance, the first path 114 of the underlay 112 between devices 118(1) and 118(2) may be a shortest path that offers minimal delay. In contrast, the second path 116 of the underlay 112, which includes devices 118(1), 118(2), and 118(3), may be a more secure path as device 118(3) represents or otherwise includes a firewall.

In some examples, the SD-WAN system (e.g., an SD-WAN controller) may receive underlay path identification data associated with an underlay path (e.g., first path 114 and/or second path 116) of an overlay network 108(1), the overlay network 108(1) disposed between a first edge node 106(1) and a second edge node 106(2) of the SD-WAN system. In some examples, the underlay path identification data may include a Segment-Routing underlay path's key. For instance, the underlay path identification data may include a headend IP address associated with the first path 114, a tail end IP address associated with the first path 114, and/or a color associated with the first path 114, a segment identifier or micro segment identifier associated with the first path 114, or other path identification data. In some examples, metrics associated with the underlay path may be received and/or determined. For instance, these metrics may include whether the path is a secure path (e.g., whether the path includes any network security components, firewalls, etc.), a number of hops in the path, whether the path is a shortest path or a low latency path, whether the path is a high bandwidth path, or the like.

In some examples, the SD-WAN system may generate an SD-WAN session that is to utilize the underlay path (e.g., the first path 114) for sending traffic through the overlay network 108(1) from the first edge node 106(1) to the second edge node 106(2). In some examples, generating the SD-WAN session may include generating a new SD-WAN session key identifying the session. The SD-WAN session key may include values for a source IP address, destination IP address, source Color, remote Color, encapsulation, and sub-encapsulation.

In some examples, the SD-WAN session may be generated based at least in part on the underlay path identification data. In some examples, generating the SD-WAN session may include mapping the underlay path (e.g., the first path 114) to the SD-WAN session such that the traffic sent over the SD-WAN session traverses the first path 114 of the overlay network 108(1). For instance, the first path 114 may be mapped to the newly created SD-WAN session by mapping a headend IP address associated with the first path 114 to a source IP address associated with the SD-WAN session, mapping a tail end IP address associated with the first path 114 to a destination IP address associated with the SD-WAN session, and/or mapping a path identifier associated with the first path 114 to a path key value associated with the SD-WAN session. In some examples, the path identifier may be a segment routing color associated with the first path 114. In some examples, the underlay path identification data that is received may include the headend IP address, the tail end IP address, and the path identifier.

In some examples, generating the SD-WAN session may additionally or alternatively include binding the SD-WAN session to a data plane output forwarding chain associated with the first path 114 such that the traffic sent over the SD-WAN session traverses the first path 114 of the overlay network 108(1). In some examples, binding the SD-WAN session to the data plane output forwarding chain associated with the first path 114 may entail associating, with the SD-WAN session, a binding segment identifier (SID) associated with the first path 114.

In some instances, the SD-WAN system may generate multiple different SD-WAN sessions for different, potential underlay paths that may be utilized. For instance, the SD-WAN system may generate different SD-WAN sessions for each one of the first path 114, the second path 116, other underlay paths of the overlay network 108(1) not shown, as well as underlay paths through the overlay network 108(N) not shown. By establishing specific SD-WAN session for specific underlay paths, when the SD-WAN system decides which underlay path to use for a flow, the SD-WAN session is selecting the overlay at the same time.

In some examples, the SD-WAN system may associate different SD-WAN sessions with different policies based on the underlay path that a specific SD-WAN session is bound to. For instance, the SD-WAN system may use certain SD-WAN sessions where a firewall is included in the underlay 112 for traffic that requires such, based on policy. Additionally, the SD-WAN system may use an SD-WAN session that is bound to a shortest path in the underlay 112 for traffic that requires minimal latency and/or delay. In examples, different underlay paths may include different combinations of security and/or networking components and/or services.

In some examples, as packets of a flow move through the SD-WAN system, the packets may be classified (e.g., at an SD-WAN edge node 106, classifier, etc.) based on policy to determine which one of the overlay networks 108 to send the packets through, as well as determine a specific underlay path of that overlay network for routing the packets. For instance, the packet may be classified based on a policy to determine if it needs to be sent via a secure underlay path (e.g., second path 116), a minimum delay underlay path (e.g., first path 114), a high bandwidth underlay path, or an underlay path providing any combination thereof.

In some examples, once the underlay path for transporting the traffic is determined and/or selected, the packets/traffic may be modified to include information for steering the traffic along the underlay path. In some examples, this information may be a binding SID that is indicative of a label stack (e.g., MPLS label stack) for steering the packet along the underlay path. In some examples, the information may include next hop addresses for the underlay devices 118 and/or nodes of the underlay path, or any other type of networking/routing information for indicating the path to the overlay networks 108. In other words, the information that is included in the packet due to the modifying may convey the identity of the underlay path to the specific overlay network 108 in which that underlay path is located.

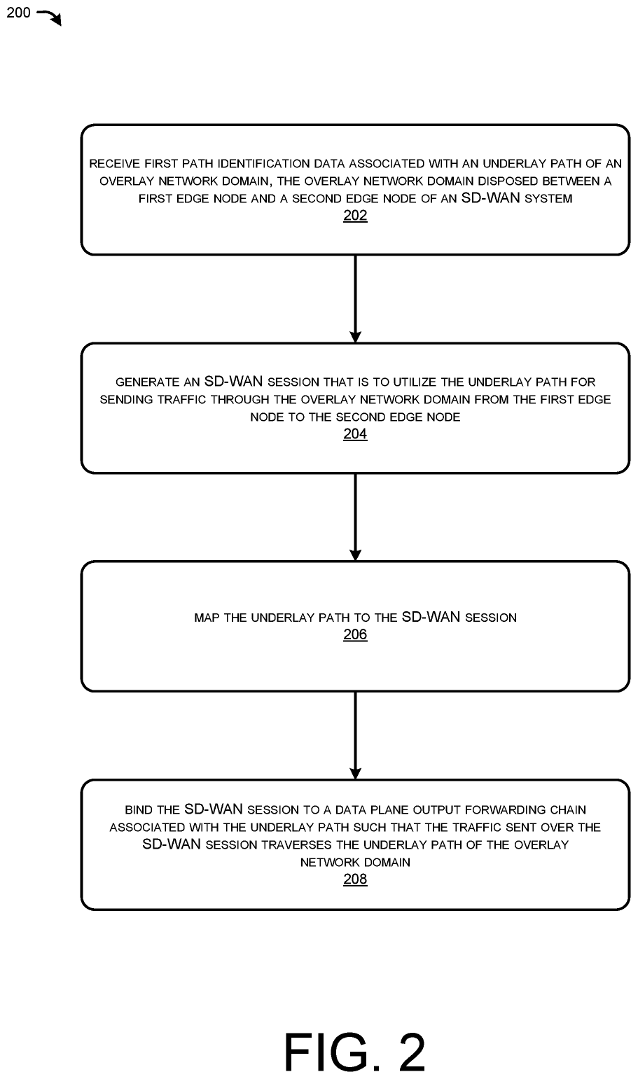

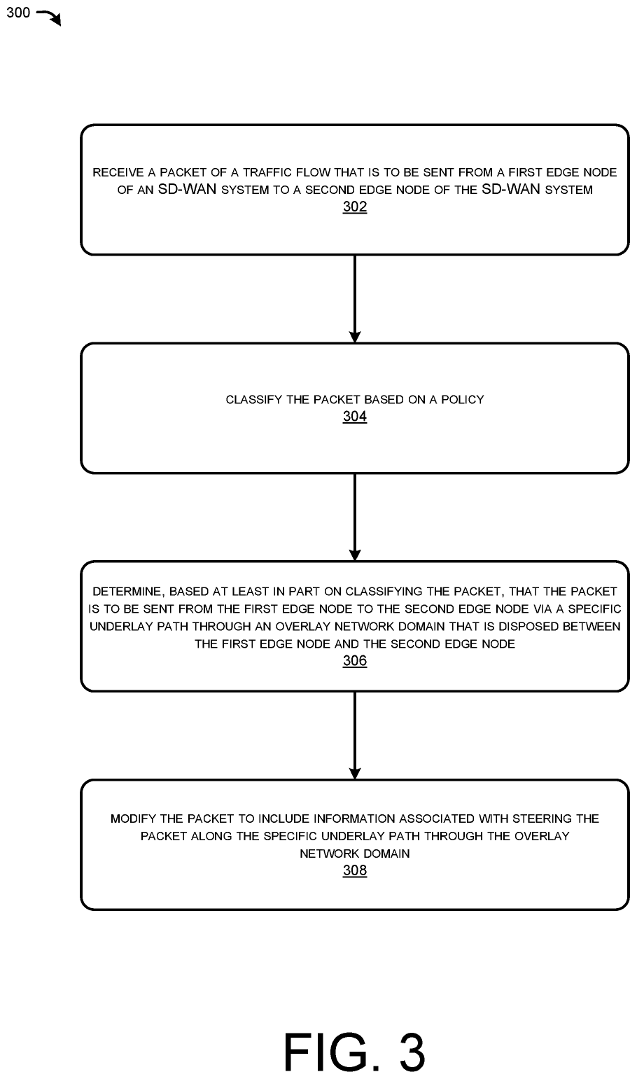

FIGS. 2 and 3 are flow diagrams illustrating example methods 200 and 300 associated with the techniques described herein. The logical operations described herein with respect to FIGS. 2 and 3 may be implemented (1) as a sequence of computer-implemented acts or program modules running on a computing system and/or (2) as interconnected machine logic circuits or circuit modules within the computing system.

The implementation of the various components described herein is a matter of choice dependent on the performance and other requirements of the computing system. Accordingly, the logical operations described herein are referred to variously as operations, structural devices, acts, or modules. These operations, structural devices, acts, and modules can be implemented in software, in firmware, in special purpose digital logic, and any combination thereof. It should also be appreciated that more or fewer operations might be performed than shown in FIGS. 2 and 3 and described herein. These operations can also be performed in parallel, or in a different order than those described herein. Some or all of these operations can also be performed by components other than those specifically identified. Although the techniques described in this disclosure is with reference to specific components, in other examples, the techniques may be implemented by less components, more components, different components, or any configuration of components.

With reference to FIG. 2, the method 200 begins at operation 202, which includes receiving first path identification data associated with an underlay path of an overlay network domain, the overlay network domain disposed between a first edge node and a second edge node of an SD-WAN system. For instance, any one of the entities of the SD-WAN system illustrated in FIG. 1, such as the SD-WAN branch 102, the SD-WAN data center 104, the SD-WAN edge nodes 106, as well as other entities not illustrated (e.g., an SD-WAN controller), may receive the first path identification data associated with an underlay path (e.g., first path 114, second path 116) of an overlay network 108(1) disposed between a first edge node 106(1) and a second edge node 106(2) of the SD-WAN system.

In some examples, the first path identification data may include a Segment-Routing underlay path's key. For instance, the underlay path identification data may include a headend IP address associated with the underlay path, a tail end IP address associated with the underlay path, a color associated with the underlay path, a segment identifier or micro segment identifier associated with the underlay path, or other path identification data. In some examples, metrics associated with the underlay path may be received and/or determined. For instance, these metrics may include whether the path is a secure path (e.g., whether the path includes any network security components, firewalls, etc.), a number of hops in the path, whether the path is a shortest path or a low latency path, whether the path is a high bandwidth path, or the like.

At operation 204, the method 200 includes generating an SD-WAN session that is to utilize the underlay path for sending traffic through the overlay network domain from the first edge node to the second edge node. For instance, any one of the entities of the SD-WAN system illustrated in FIG. 1, as well as other entities not illustrated (e.g., an SD-WAN controller), may generate the SD-WAN session that is to utilize the underlay path (e.g., first path 114, second path 116) for sending traffic through the overlay network 108(1) from the first edge node 106(1) to the second edge node 106(2).

At operation 206, the method 200 includes mapping the underlay path to the SD-WAN session. For instance, any one of the entities of the SD-WAN system illustrated in FIG. 1, as well as other entities not illustrated (e.g., an SD-WAN controller), may map the underlay path (e.g., first path 114, second path 116) to the SD-WAN session. In examples, the underlay path may be mapped to the newly created SD WAN session by mapping a headend IP address associated with the underlay path to a source IP address associated with the SD-WAN session, mapping a tail end IP address associated with the underlay path to a destination IP address associated with the SD-WAN session, and/or mapping a path identifier associated with the underlay path to a path key value associated with the SD-WAN session. In some examples, the path identifier may be a segment routing color associated with the underlay path. In some examples, the first path identification data that is received may include the headend IP address, the tail end IP address, and the path identifier.

At operation 208, the method 200 includes binding the SD-WAN session to a data plane output forwarding chain associated with the underlay path such that the traffic sent over the SD-WAN session traverses the underlay path of the overlay network domain. For instance, any one of the entities of the SD-WAN system illustrated in FIG. 1, as well as other entities not illustrated (e.g., an SD-WAN controller), may bind the SD-WAN session to the data plane output forwarding chain associated with the underlay path (e.g., first path 114, second path 116). In some examples, binding the SD-WAN session to the data plane output forwarding chain associated with the underlay path may entail associating, with the SD-WAN session, a binding segment identifier (SID) associated with the underlay path.

With reference to FIG. 3, the method 300 begins at operation 302, which includes receiving a packet of a traffic flow that is to be sent from a first edge node of an SD-WAN system to a second edge node of the SD-WAN system. For instance, any one of the entities of the SD-WAN system illustrated in FIG. 1, as well as other entities not illustrated (e.g., an SD-WAN controller), may receive the packet of the traffic flow that it to be sent from the first edge node 106(1) to the second edge node 106(2).

At operation 304, the method 300 includes classifying the packet based on a policy. For instance, any one of the entities of the SD-WAN system illustrated in FIG. 1, as well as other entities not illustrated (e.g., an SD-WAN controller), may classify the packet based on the policy. In some examples, classifying the packet may include determining what type of traffic the packet is associated with (e.g., voice traffic, web traffic, video traffic, streaming, audio, application traffic, etc.). In some examples, classifying the packet may include associating a classification with the packet that is known to the SD-WAN system based on the contents of the packet.

At operation 306, the method 300 includes determining, based at least in part on classifying the packet, that the packet is to be sent from the first edge node to the second edge node via a specific underlay path through an overlay network domain that is disposed between the first edge node and the second edge node. For instance, any one of the entities of the SD-WAN system illustrated in FIG. 1, as well as other entities not illustrated (e.g., an SD-WAN controller), may determine that the packet is to be sent via the specific underlay path (e.g., first path 114, second path 116, etc.) through the overlay network 108(1). In other words, an overlay path/underlay path combination may be determined and/or selected that is best suited for handling the classification of the packet/traffic. As an example, if the traffic needs minimum delay or low latency, the first path 114 (e.g., shortest underlay path) may be selected. Additionally, as another example, if the traffic needs to be filtered or sent through a firewall, then the second path 116 which includes the firewall device 118 (3) may be selected.

At operation 308, the method 300 includes modifying the packet to include information associated with steering the packet along the specific underlay path through the overlay network domain. For instance, any one of the entities of the SD-WAN system illustrated in FIG. 1, as well as other entities not illustrated (e.g., an SD-WAN controller), may modify the packet to include the information associated with steering the packet along the specific underlay path (e.g., first path 114, second path 116, legacy path, default path, etc.) through the overlay network 108(1). In some examples, modifying the packet to include the information may be based at least in part on determining that the packet is to be sent from the first edge node to the second edge node via the specific underlay path. In some examples, the information may include the binding SID described herein.

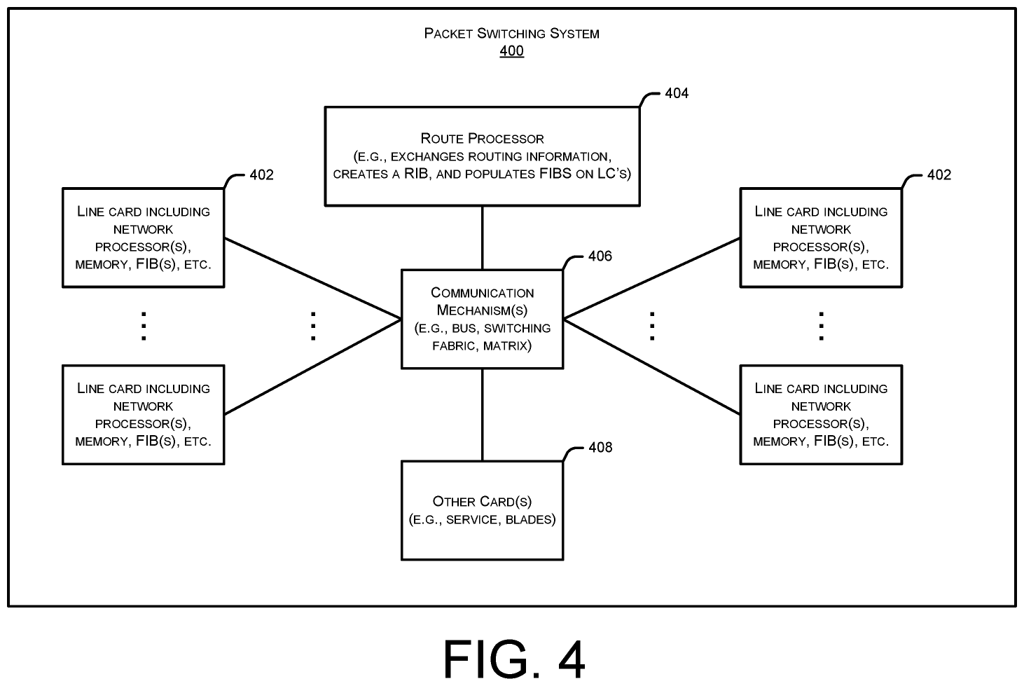

FIG. 4 is a block diagram illustrating an example packet switching system 400 (or packet switching device) that can be utilized to implement various aspects of the technologies disclosed herein. In some examples, the packet switching system 400 may be employed in various networks and architectures, such as, for example, the architecture 100 described with respect to FIG. 1. For instance, the SD-WAN edge nodes 106 and/or the underlay devices 118 may include similar components as the packet switching system 400.

In some examples, the packet switching system 400 may comprise multiple line card(s) 402, each with one or more network interfaces for sending and receiving packets over communications links (e.g., possibly part of a link aggregation group). The packet switching system 400 may also have a control plane with one or more route processor 404 elements for managing the control plane and/or control plane processing of packets associated with forwarding of packets in a network, including, but not limited to, exchanging routing information, creating routing information base(s) (RIBs), and/or populating forward information base(s) (FIBs) on LCs. The packet switching system 400 may also include other cards 408 (e.g., service cards, blades) which include processing elements that are used to process (e.g., forward/send, drop, manipulate, change, modify, receive, create, duplicate, apply a service) packets associated with forwarding of packets in a network. The packet switching system 400 may comprise hardware-based communication mechanism 406 (e.g., bus, switching fabric, and/or matrix, etc.) for allowing its different entities to communicate. Line card(s) 402 may typically perform the actions of being both an ingress and/or an egress line card 402 in regard to multiple other particular packets and/or packet streams being received by, or sent from, packet switching system 400.

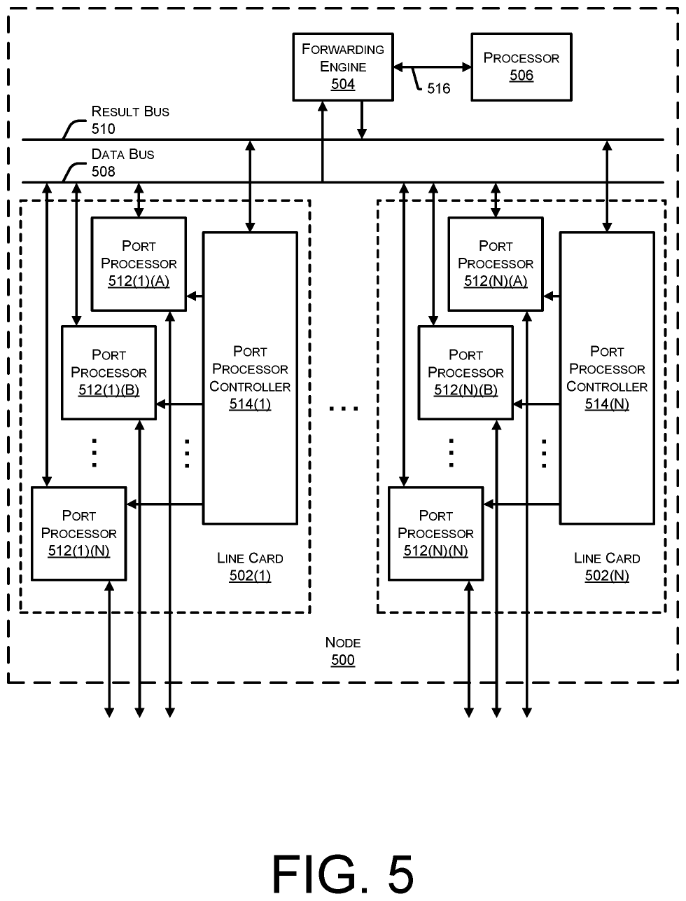

FIG. 5 is a block diagram illustrating certain components of an example node 500 that can be utilized to implement various aspects of the technologies disclosed herein. In some examples, node(s) 500 may be employed in various architectures and networks, such as, for example, the architecture 100 described with respect to FIG. 1. For instance, the SD-WAN edge nodes 106 and/or the underlay devices 118 may include similar components as the node 500.

In some examples, the node 500 may include any number of line cards 502 (e.g., line cards 502(1)-(N), where N may be any integer greater than 1) that are communicatively coupled to a forwarding engine 504 (also referred to as a packet forwarder) and/or a processor 506 via a data bus 508 and/or a result bus 510. Line cards 502(1)-(N) may include any number of port processors 512(1)(A)-(N)(N) which are controlled by port processor controllers 514(1)-(N), where N may be any integer greater than 1. Additionally, or alternatively, forwarding engine 504 and/or processor 506 are not only coupled to one another via the data bus 508 and the result bus 510, but may also communicatively coupled to one another by a communications link 516.

The processors (e.g., the port processor(s) 512 and/or the port processor controller(s) 514) of each line card 502 may be mounted on a single printed circuit board. When a packet or packet and header are received, the packet or packet and header may be identified and analyzed by node 500 (also referred to herein as a router) in the following manner. Upon receipt, a packet (or some or all of its control information) or packet and header may be sent from one of port processor(s) 512(1)(A)-(N)(N) at which the packet or packet and header was received and to one or more of those devices coupled to the data bus 508 (e.g., others of the port processor(s) 512(1)(A)-(N)(N), the forwarding engine 504 and/or the processor 506). Handling of the packet or packet and header may be determined, for example, by the forwarding engine 504. For example, the forwarding engine 504 may determine that the packet or packet and header should be forwarded to one or more of port processors 512(1)(A)-(N)(N). This may be accomplished by indicating to corresponding one(s) of port processor controllers 514(1)-(N) that the copy of the packet or packet and header held in the given one(s) of port processor(s) 512(1)(A)-(N)(N) should be forwarded to the appropriate one of port processor(s) 512(1)(A)-(N)(N). Additionally, or alternatively, once a packet or packet and header has been identified for processing, the forwarding engine 504, the processor 506, and/or the like may be used to process the packet or packet and header in some manner and/or may add packet security information in order to secure the packet. On a node 500 sourcing such a packet or packet and header, this processing may include, for example, encryption of some or all of the packet's and/or header's information, the addition of a digital signature, and/or some other information and/or processing capable of securing the packet or packet and header. On a node 500 receiving such a processed packet or packet and header, the corresponding process may be performed to recover or validate the packet's and/or header's information that has been secured.

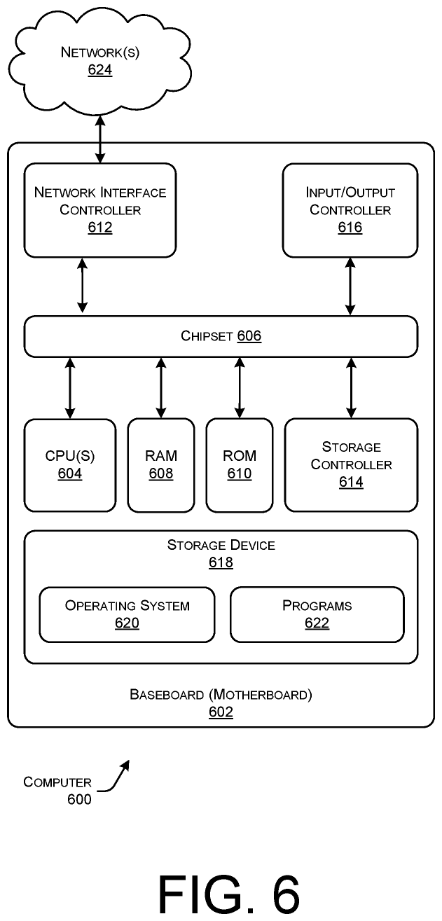

FIG. 6 is a computer architecture diagram showing an illustrative computer hardware architecture for implementing a computing device that can be utilized to implement aspects of the various technologies presented herein. The computer architecture shown in FIG. 6 may be illustrative of a conventional server computer, router, switch, node, workstation, desktop computer, laptop, tablet, network appliance, e-reader, smartphone, load balancer, or other computing device, and can be utilized to execute any of the software components presented herein.

The computer 600 includes a baseboard 602, or “motherboard,” which is a printed circuit board to which a multitude of components or devices can be connected by way of a system bus or other electrical communication paths. In one illustrative configuration, one or more central processing units (“CPUs”) 604 operate in conjunction with a chipset 606. The CPUs 604 can be standard programmable processors that perform arithmetic and logical operations necessary for the operation of the computer 600.

The CPUs 604 perform operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

The chipset 606 provides an interface between the CPUs 604 and the remainder of the components and devices on the baseboard 602. The chipset 606 can provide an interface to a RAM 608, used as the main memory in the computer 600. The chipset 606 can further provide an interface to a computer-readable storage medium such as a read-only memory (“ROM”) 610 or non-volatile RAM (“NVRAM”) for storing basic routines that help to startup the computer 600 and to transfer information between the various components and devices. The ROM 610 or NVRAM can also store other software components necessary for the operation of the computer 600 in accordance with the configurations described herein.

The computer 600 can operate in a networked environment using logical connections to remote computing devices and computer systems through a network. The chipset 606 can include functionality for providing network connectivity through a NIC 612, such as a gigabit Ethernet adapter. The NIC 612 is capable of connecting the computer 600 to other computing devices over the network 624, such as any of the entities/systems/devices described above with reference to FIGS. 1-5. It should be appreciated that multiple NICs 612 can be present in the computer 600, connecting the computer to other types of networks and remote computer systems. In some examples, the NIC 612 may be configured to perform at least some of the techniques described herein.

The computer 600 can be connected to a storage device 618 that provides non-volatile storage for the computer. The storage device 618 can store an operating system 620, programs 622, and data, which have been described in greater detail herein. The storage device 618 can be connected to the computer 600 through a storage controller 614 connected to the chipset 606. The storage device 618 can consist of one or more physical storage units. The storage controller 614 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The computer 600 can store data on the storage device 618 by transforming the physical state of the physical storage units to reflect the information being stored. The specific transformation of physical state can depend on various factors, in different embodiments of this description. Examples of such factors can include, but are not limited to, the technology used to implement the physical storage units, whether the storage device 618 is characterized as primary or secondary storage, and the like.

For example, the computer 600 can store information to the storage device 618 by issuing instructions through the storage controller 614 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computer 600 can further read information from the storage device 618 by detecting the physical states or characteristics of one or more particular locations within the physical storage units.

In addition to the mass storage device 618 described above, the computer 600 can have access to other computer-readable storage media to store and retrieve information, such as program modules, data structures, or other data. It should be appreciated by those skilled in the art that computer-readable storage media is any available media that provides for the non-transitory storage of data and that can be accessed by the computer 600. In some examples, the operations performed by the architecture 100 and or any components included therein, may be supported by one or more devices similar to computer 600. Stated otherwise, some or all of the operations performed by the architecture 100 and or any components included therein, may be performed by one or more computer devices, which may be similar to the computer 600, operating in a scalable arrangement.

By way of example, and not limitation, computer-readable storage media can include volatile and non-volatile, removable, and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage device 618 can store an operating system 620 utilized to control the operation of the computer 600. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage device 618 can store other system or application programs and data utilized by the computer 600.

In one embodiment, the storage device 618 or other computer-readable storage media is encoded with computer-executable instructions which, when loaded into the computer 600, transform the computer from a general-purpose computing system into a special-purpose computer capable of implementing the embodiments described herein. These computer-executable instructions transform the computer 600 by specifying how the CPUs 604 transition between states, as described above. According to one embodiment, the computer 600 has access to computer-readable storage media storing computer-executable instructions which, when executed by the computer 600, perform the various processes and functionality described above with regard to FIGS. 1-5, and herein. The computer 600 can also include computer-readable storage media having instructions stored thereupon for performing any of the other computer-implemented operations described herein.

The computer 600 can also include one or more input/output controllers 616 for receiving and processing input from a number of input devices, such as a keyboard, a mouse, a touchpad, a touch screen, an electronic stylus, or other type of input device. Similarly, an input/output controller 616 can provide output to a display, such as a computer monitor, a flat-panel display, a digital projector, a printer, or other type of output device. It will be appreciated that the computer 600 might not include all of the components shown in FIG. 6, can include other components that are not explicitly shown in FIG. 6, or might utilize an architecture completely different than that shown in FIG. 6.

The computer 600 may include one or more hardware processors (processors) configured to execute one or more stored instructions. The processor(s) may comprise one or more cores. Further, the computer 600 may include one or more network interfaces configured to provide communications between the computer 600 and other devices. The network interfaces may include devices configured to couple to personal area networks (PANs), wired and wireless local area networks (LANs), wired and wireless wide area networks (WANs), and so forth. For example, the network interfaces may include devices compatible with Ethernet, Wi-Fi™, and so forth.

The programs 622 may comprise any type of programs or processes to perform the techniques described in this disclosure for achieving hybrid control over overlay and underlay path selection by exposing underlay paths to a software-defined wide area network architecture and generating individual SD-WAN sessions for individual underlay paths. In this way, SD-WAN path selection that incorporates both the underlay path and overlay path can naturally be applied on those SD-WAN sessions.

While the invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative some embodiments that fall within the scope of the claims of the application.

What is claimed is:

1. A method comprising:
receiving first path identification data associated with an underlay path of an overlay network domain, the overlay network domain disposed between a first edge node and a second edge node of a software-defined wide area network (SD-WAN);
generating an SD-WAN session that is to utilize the underlay path for sending traffic through the overlay network domain from the first edge node to the second edge node;
mapping the underlay path to the SD-WAN session; and
binding the SD-WAN session to a data plane output forwarding chain associated with the underlay path such that the traffic sent over the SD-WAN session traverses the underlay path of the overlay network domain.

2. The method of claim 1, further comprising:
receiving a packet of a traffic flow;
classifying the packet based on a policy to determine whether the packet is to be sent from the first edge node to the second edge node via a specific underlay path; and
based at least in part on determining that the packet is to be sent from the first edge node to the second edge node via the underlay path, modifying the packet to include a binding segment identifier (SID) that is indicative of a label stack for steering the packet along the underlay path.

3. The method of claim 1, wherein mapping the SD-WAN session to the underlay path comprises:
mapping a headend IP address associated with the underlay path to a source IP address associated with the SD-WAN session;
mapping a tail end IP address associated with the underlay path to a destination IP address associated with the SD-WAN session; and
mapping a path identifier associated with the underlay path to a path key value associated with the SD-WAN session.

4. The method of claim 3, wherein the path identifier is a segment routing color associated with the underlay path.

5. The method of claim 3, wherein the first path identification data includes the headend IP address, the tail end IP address, and the path identifier.

6. The method of claim 1, wherein binding the SD-WAN session to the data plane output forwarding chain associated with the underlay path comprises associating, with the SD-WAN session, a binding segment identifier (SID) associated with the underlay path.

7. The method of claim 1, wherein the underlay path is a first underlay path and the SD-WAN session is a first SD-WAN session, the method further comprising:
receiving second path identification data associated with a second underlay path between the first edge node and the second edge node;
generating a second SD-WAN session that is to utilize the second underlay path;
mapping the second underlay path to the second SD-WAN session; and
binding the second SD-WAN session to another data plane output forwarding chain associated with the second underlay path.

8. The method of claim 7, wherein the first underlay path is a minimum delay path and the second underlay path includes a firewall, and wherein the first underlay path and the second underlay path are selected for routing the traffic through the overlay network domain based on a policy.

9. The method of claim 1, wherein the overlay network domain is distinguishable from another overlay network domain that is (i) disposed between the first edge node and the second edge node and (ii) capable of being utilized to send the traffic from the first edge node to the second edge node.

10. A system comprising:
one or more processors; and
one or more non-transitory computer-readable media storing instructions that, when executed by the one or more processors, cause the system to perform operations comprising:
receiving first path identification data associated with an underlay path of an overlay network domain, the overlay network domain disposed between a first edge node and a second edge node of a software-defined wide area network (SD-WAN);
generating an SD-WAN session that is to utilize the underlay path for sending traffic through the overlay network domain from the first edge node to the second edge node;
mapping the underlay path to the SD-WAN session; and
binding the SD-WAN session to a data plane output forwarding chain associated with the underlay path such that the traffic sent over the SD-WAN session traverses the underlay path of the overlay network domain.

11. The system of claim 10, the operations further comprising:
receiving a packet of a traffic flow;
classifying the packet based on a policy to determine whether the packet is to be sent from the first edge node to the second edge node via a specific underlay path; and based at least in part on determining that the packet is to be sent from the first edge node to the second edge node via the underlay path, modifying the packet to include a binding segment identifier (SID) that is indicative of a label stack for steering the packet along the underlay path.

12. The system of claim 10, wherein mapping the SD-WAN session to the underlay path comprises:
mapping a headend IP address associated with the underlay path to a source IP address associated with the SD-WAN session;
mapping a tail end IP address associated with the underlay path to a destination IP address associated with the SD-WAN session; and
mapping a path identifier associated with the underlay path to a path key value associated with the SD-WAN session.

13. The system of claim 12, wherein the path identifier is a segment routing color associated with the underlay path.

14. The system of claim 12, wherein the first path identification data includes the headend IP address, the tail end IP address, and the path identifier.

15. The system of claim 10, wherein binding the SD-WAN session to the data plane output forwarding chain associated with the underlay path comprises associating, with the SD-WAN session, a binding segment identifier (SID) associated with the underlay path.

16. The system of claim 10, wherein the underlay path is a first underlay path and the SD-WAN session is a first SD-WAN session, the operations further comprising:
receiving second path identification data associated with a second underlay path between the first edge node and the second edge node;
generating a second SD-WAN session that is to utilize the second underlay path;
mapping the second underlay path to the second SD-WAN session; and
binding the second SD-WAN session to another data plane output forwarding chain associated with the second underlay path.

17. The system of claim 16, wherein the first underlay path is a minimum delay path and the second underlay path includes a firewall, and wherein the first underlay path and the second underlay path are selected for routing the traffic through the overlay network domain based on a policy.

18. The system of claim 10, wherein the overlay network domain is distinguishable from another overlay network domain that is (i) disposed between the first edge node and the second edge node and (ii) capable of being utilized to send the traffic from the first edge node to the second edge node.

19. One or more non-transitory computer-readable media storing instructions that, when executed, cause one or more computing devices to perform operations comprising:
receiving first path identification data associated with an underlay path of an overlay network domain, the overlay network domain disposed between a first edge node and a second edge node of a software-defined wide area network (SD-WAN);
generating an SD-WAN session that is to utilize the underlay path for sending traffic through the overlay network domain from the first edge node to the second edge node;
mapping the underlay path to the SD-WAN session; and
binding the SD-WAN session to a data plane output forwarding chain associated with the underlay path such that the traffic sent over the SD-WAN session traverses the underlay path of the overlay network domain.

20. The one or more non-transitory computer-readable media of claim 19, the operations further comprising:
receiving a packet of a traffic flow;
classifying the packet based on a policy to determine whether the packet is to be sent from the first edge node to the second edge node via a specific underlay path; and
based at least in part on determining that the packet is to be sent from the first edge node to the second edge node via the underlay path, modifying the packet to include a binding segment identifier (SID) that is indicative of a label stack for steering the packet along the underlay path.
